(19) United States
(12) Patent Application Publication
(10) Pub. No.: US 2010/0329171 A1
(43) Pub. Date: Dec. 30, 2010

(54) Method and Apparatus for Handling Subframe of Multimedia Broadcast Multicast Service Single Frequency Network in Wireless Communication System

(76) Inventors: Richard Lee-Chee Kuo, Taipei City (TW); Ko-Chiang Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/825,363

(22) Filed: Jun. 29, 2010

Related U.S. Application Data
(60) Provisional application No. 61/221,093, filed on Jun. 29, 2009.

(51) Int. Cl. H04H 20/71

(52) U.S. Cl. 370/312

(57) ABSTRACT

A method for handling Multimedia Broadcast Multicast Service Single Frequency Network (MBSFN) subframe in a network terminal of a wireless communication system includes configuring a plurality of MBSFN subframes in a cell, and scheduling downlink unicast transmission in an unused MBSFN subframe of the plurality of MBSFN subframes for a user equipment which is not receiving any MBMS service.

### CROSS REFERENCE TO RELATED APPLICATIONS

This application claims the benefit of U.S. Provisional No. 61/221,093, filed on Jun. 29, 2009 and entitled “Method and apparatus for reusing unused MBSFN subframes in a wireless communication system”, the contents of which are incorporated herein by reference.

### BACKGROUND OF THE INVENTION

1. Field of the Invention

The present invention relates to a method and apparatus for handling Multimedia Broadcast Multicast Service Single Frequency Network (MBSFN) subframe in a wireless communication system, and more particularly, to a method and apparatus capable of scheduling an unused MBSFN subframe for a user equipment (UE) which is not receiving any MBMS service, to enhance resource usage efficiency of a network terminal.

2. Description of the Prior Art

To enhance multimedia performance of the 3G mobile telecommunications system, the 3rd Generation Partnership Project (3GPP) introduces a Multimedia Broadcast Multicast Service (MBMS), which is a point-to-multipoint (p-t-m) bearer service established on an existing network architecture of the Universal Mobile Telecommunications System (UMTS). MBMS allows a single source terminal to simultaneously transmit data to multiple user equipments (UEs) via Internet Protocol (IP) packets.

However, as the multimedia performance of mobile devices advances, consumers are more interested to have multimedia or mobile TV services via the mobile devices. In order to meet such requirement, the 3GPP introduces an enhanced MBMS (eMBMS) in a specification of long term evolution (LTE) Release-9, to support high quality streaming multimedia and real-time MBMS services.

The eMBMS introduces a single frequency network (SFN) operation for MBMS transmission, i.e. MBMS Single Frequency Network (MBSFN), to reduce service interruption due to frequency switching during transmissions.

In addition, only two logical channels are defined in eMBMS to support p-t-m downlink transmission: Multicast Control Channel (MCCH) and Multicast Traffic Channel (MTCH). MCCH is utilized for transmitting control messages of all MBMS services in an MBSFN, and MTCH is utilized for transmitting session data of an MBMS service. The session data relates to contents of the MBMS service. Both MCCH and MTCH are mapped to a transmission channel newly defined by eMBMS, i.e. Multicast Channel (MCH).

In general, an MBSFN has an MCCH. However, when an evolved Node B (eNB) is simultaneously covered by multiple MBSFN areas, the eNB may have multiple MCCHs. Besides, since an MBSFN area can simultaneously support multiple MBMS services, and different MBMS services may have different requirements, such as Quality of Service (QoS), Block Error Rate (BLER), according to different characteristics, an MBSFN area may have multiple MCHs. Different MCHs meet requirements of different MBMS services by applying different modulation and encoding schemes. MCCH is mainly responsible for providing these MCHs with the following control parameters:

(1) Modulation and Coding Scheme (MCS): illustrating encoding and modulation scheme of each MCH.

(2) MBMS service list: listing MBMS services currently provided by each MCH, and including MBMS service ID and session ID, and further including corresponding Logical channel ID (LCID) of MBMS services.

(3) MCH Sub-frame Allocation Pattern (MSAP): defining a pattern of sub-frames used by each MCH in a scheduling period. A set of these sub-frames used by one MCH is called an MSAP occasion. In each MSAP occasion, a network terminal can multiplex MCCH and MTCHs corresponding to different MBMS services on a Physical Multicast Channel (PMCH), which is a physical layer channel of MCH, for transmission.

Since an MCH may simultaneously provide multiple MBMS services, and some MBMS services are bursty, i.e. an occasion of showing contents of an MBMS service is uncertain, there may be unused MBSFN subframes in each MASP occasion. The amount of unused MBSFN subframes depends on traffic pattern, MSAP configuration, etc. Besides, it is unsuitable to change MBSFN subframe configuration in broadcast control channel (BCCH) frequently. Therefore, after a MBMS session is stopped, it is possible that corresponding MBSFN subframes are not released in time, i.e. these MBSFN subframes are not removed from configuration in time. Therefore, in order to enhance resource usage efficiency, the unused MBSFN subframes should be reused in unicast transmissions.

Under such a situation, 3GPP change request R2-093773 proposes to use a Dynamic Scheduling Information (DSI) to indicate the unused MBSFN subframes, which means the network terminal can schedule unicast transmissions in the unused MBSFN subframes only for UEs which are receiving the MBMS services. However, the method disclosed by the change request R2-093773 is too restrictive for the network terminal.

In detail, according to the current downlink shared channel (DL-SCH) reception procedure, a UE detects a Physical Downlink Control Channel (PDCCH) by decoding a control region in a subframe, so as to get a downlink assignment. A length of the control region is set by the network terminal, e.g. 1-2 orthogonal frequency division multiplexing (OFDM) symbols in a MBSFN subframe, and 1-3 or 2-4 OFDM symbols in a non-MBSFN subframe, and can be known via a broadcast message or on a Physical Control Format Indicator Channel (PCFICH). If the downlink assignment indicates there is a transmission on a DL-SCH for the UE, the UE continues to decode following symbols of the control region, i.e. a data region, in the subframe. Besides, according to the related specification, a control region in a MBSFN subframe further contains Cell-specific reference signals (CRS). Thus, the UE can know whether there is a corresponding transmission on the DL-SCH after detecting the PDCCH. Under such a situation, reusing the unused MBSFN subframes for unicast transmissions can be achieved by keeping the control region of the MBSFN subframe and filling the data region with unicast transmissions. In other words, it is an unnecessary restriction for the network terminal to schedule unicast transmissions in the unused MBSFN subframes only for UEs which are receiving the MBMS services, and the restriction reduces transmission resource usage efficiency.

### SUMMARY OF THE INVENTION

It is therefore an objective of the present invention to provide a method and apparatus for handling Multimedia Broadcast Multicast Service Single Frequency Network (MBSFN) subframe in a wireless communication system.

The present invention discloses a method for handling Multimedia Broadcast Multicast Service Single Frequency Network (MBSFN) subframe in a network terminal of a wireless communication system. The method includes steps of configuring a plurality of MBSFN subframes in a cell, and scheduling a downlink unicast transmission in an unused MBSFN subframe of the plurality of MBSFN subframes for a user equipment (UE). The UE is not receiving any Multimedia Broadcast Multicast Service (MBMS) service.

The present invention further discloses a communication device for handling Multimedia Broadcast Multicast Service Single Frequency Network (MBSFN) subframe in a network terminal of a wireless communication system. The communication device includes a processor for executing a program, and a memory coupled to the processor for storing the program. The program includes steps of configuring a plurality of MBSFN subframes in a cell, and scheduling a downlink unicast transmission in an unused MBSFN subframe of the plurality of MBSFN subframes for a user equipment (UE). The UE is not receiving any Multimedia Broadcast Multicast Service (MBMS) service.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communications system.

FIG. 2 is a function block diagram of a wireless communications device.

FIG. 3 is a schematic diagram of a program code of FIG. 2.

FIG. 4 is a schematic diagram of a process according to an embodiment of the present invention.

### DETAILED DESCRIPTION

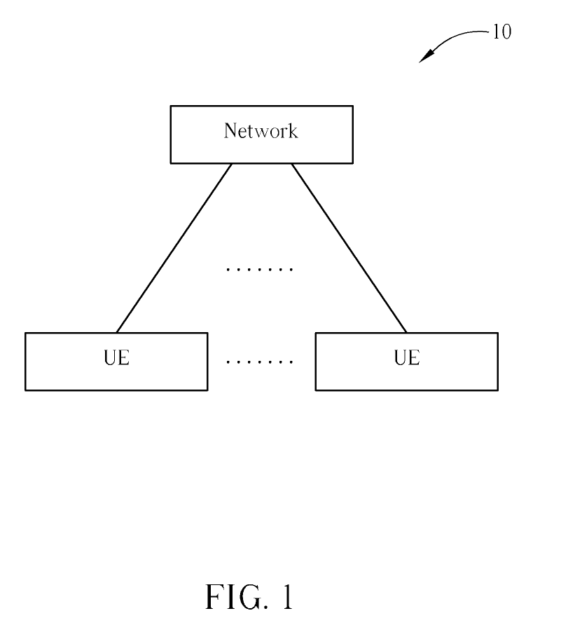

Please refer to FIG. 1, which is a schematic diagram of a wireless communications system 10. The wireless communications system 10 is preferred to be an LTE-advanced (LTE-A) system, and is briefly composed of a network and a plurality of user equipments (UEs). In FIG. 1, the network and the UEs are simply utilized for illustrating the structure of the wireless communications system 10. Practically, the network may comprise a plurality of base stations (Node Bs), radio network controllers and so on according to actual demands, and the UEs can be devices such as mobile phones, computer systems, etc.

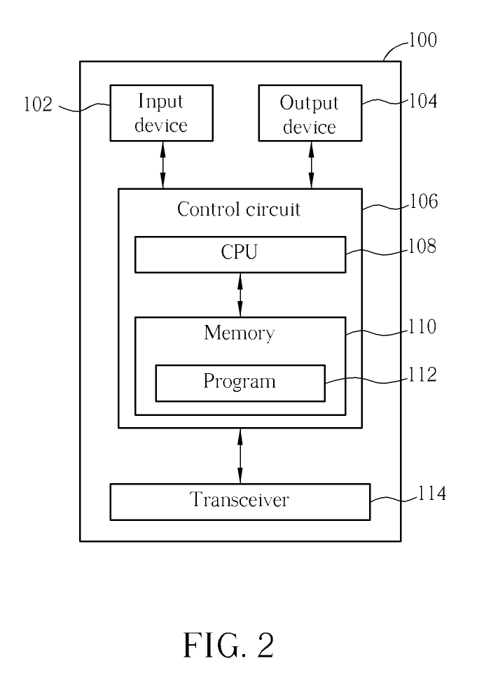

Please refer to FIG. 2, which is a functional block diagram of a communications device 100 in a wireless communications system. The communications device 100 can be utilized for realizing the network in FIG. 1. For the sake of brevity, FIG. 2 only shows an input device 102, an output device 104, a control circuit 106, a central processing unit (CPU) 108, a memory 110, a program 112, and a transceiver unit 114 of the communications device 100. In the communications device 100, the control circuit 106 executes the program code 112 in the memory 110 through the CPU 108, thereby controlling an operation of the communications device 100. The communications device 100 can receive signals inputted by a user through the input device 102, such as a keyboard, and can output images and sounds through the output device 104, such as a monitor or speakers. The transceiver unit 114 is used to receive and transmit wireless signals, for delivering received signals to the control circuit 106, and outputting signals generated by the control circuit 106 wirelessly. From a perspective of a communications protocol framework, the transceiver unit 114 can be seen as a portion of Layer 1, and the control circuit 106 can be utilized to realize functions of Layer 2 and Layer 3.

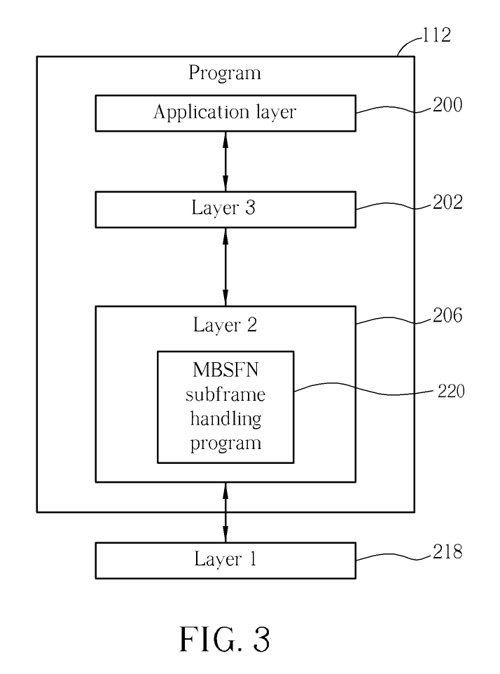

Please continue to refer to FIG. 3. FIG. 3 is a schematic diagram of the program 112 shown in FIG. 2. The program 112 includes an application layer 200, a Layer 3 202, and a Layer 2 206, and is coupled to a Layer 1 218. The Layer 3 202 performs radio resource control. The Layer 2 206 comprises a Radio Link Control (RLC) layer and a Medium Access Control (MAC) layer, and performs link control. The Layer 1 218 performs physical connections.

The wireless communication system 10 can provide an enhanced Multimedia Broadcast Multicast Service (eMBMS), to support high quality streaming multimedia and real-time MBMS services. In the eMBMS, since there may be unused MBSFN subframes in each MASP occasion. In order to enhance resource usage efficiency, the unused MBSFN subframes should be reused in unicast transmissions.

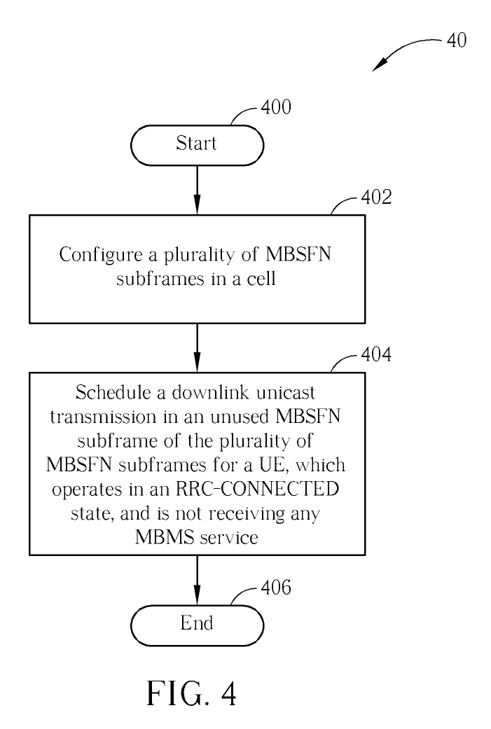

Under such a situation, the embodiment of the present invention provides a MBSFN subframe handling program 220, for reusing the unused MBSFN subframes in unicast transmissions. Please refer to FIG. 4, which is a schematic diagram of a process 40 according to an embodiment of the present invention. The process 40 is utilized for handling unused MBSFN subframe in a network terminal of a wireless communication system, and can be compiled into the MBSFN subframe handling program 220. The process 40 includes the following steps:

Step 400: Start.

Step 402: Configure a plurality of MBSFN subframes in a cell.

Step 404: Schedule a downlink unicast transmission in an unused MBSFN subframe of the plurality of MBSFN subframes for a UE, which operates in an RRC-CONNECTED state, and is not receiving any MBMS service.

Step 406: End.

According to the process 40, the network terminal can schedule the downlink unicast transmission in the unused MBSFN subframe to the UE which operates in the RRC-CONNECTED state and is not receiving any MBMS service. Since the UE which is not receiving any MBMS service can reuse the unused MBSFN subframe for the downlink unicast transmission, the network terminal can schedule transmission resources with more flexibility, and is not restricted to schedule unicast transmissions to UEs which are receiving the MBMS services. As a result, resource scheduling and usage efficiency can be effectively enhanced.

Noticeably, an objective of the embodiment of the present invention is that the network terminal can schedule a downlink unicast transmission in an unused MBSFN subframe for a UE which is not receiving any MBMS service, and modifications and alterations according to the concept should belong to the scope of the present invention. For example, the network terminal can use an information element (IE) SystemInformationBlockType2 to configure the MBSFN subframes, and definition and contents of the IE SystemInformationBlockType2 are specified in 3GPP TS 36.331-850. Furthermore, the UE can monitor PDCCH in the MBSFN subframes during an active time, to get a downlink assignment, and the active time is a period related to a Discontinuous Reception (DRX) operation during which the UE monitors PDCCH in a plurality of PDCCH-subframes. Besides, the downlink unicast transmission is preferably on a DL-SCH.

On the other hand, in order to schedule the unused MBSFN subframe for the UE which is not receiving any MBMS service, the embodiment of the present invention can preferably keep a length of a control region in the unused MBSFN subframe, and set a data region in the unused MBSFN subframe containing information about PDSCH and a plurality of CRSs for the downlink unicast transmission. In other words, the length of the control region in unused MBSFN subframe relates to a length of a control region for the downlink unicast transmission, and the data region including a PDSCH resource block and CRSs for the downlink unicast transmission.

In the prior art, the network terminal can schedule unicast transmissions in the unused MBSFN subframes only for UEs which are receiving the MBMS services, such that transmission resource can not be effectively used. In comparison, in the present invention, the network terminal schedules transmission resources with more flexibility, and can schedule an unused MBSFN subframe to a UE which is not receiving any MBMS service.

To sum up, the present invention can schedule an unused MBSFN subframe to a UE which is not receiving any MBMS service, to enhance flexibility for the network terminal to schedule resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for handling Multimedia Broadcast Multicast Service Single Frequency Network (MBSFN) subframe in a network terminal of a wireless communication system, the method comprising:
configuring a plurality of MBSFN subframes in a cell; and
scheduling a downlink unicast transmission in an unused MBSFN subframe of the plurality of MBSFN subframes for a user equipment (UE);
wherein the UE is not receiving any Multimedia Broadcast Multicast Service (MBMS) service.

2. The method of claim 1, wherein the UE operates in an RRC-CONNECTED state.

3. The method of claim 1, wherein the UE monitors Physical Downlink Control Channel (PDCCH) in the plurality of MBSFN subframes, to get a downlink assignment during an active time.

4. The method of claim 3, wherein the active time is a period relates to a Discontinuous Reception operation during which the UE monitors PDCCH in a plurality of PDCCH-subframes.

5. The method of claim 1, wherein configuring the plurality of MBSFN subframes in the cell is via an information element SystemInformationBlockType2.

6. The method of claim 1, wherein the downlink unicast transmission is transmitted on a downlink shared channel.

7. The method of claim 1 further comprising keeping a length of a control region in the unused MBSFN subframe, and setting a data region in the unused MBSFN subframe comprising information about PDSCH and a plurality of Cell-specific reference signals for the downlink unicast transmission.

8. A communication device for handling Multimedia Broadcast Multicast Service Single Frequency Network (MBSFN) subframe in a network terminal of a wireless communication system, the communication device comprising:
a processor for executing a program; and
a memory coupled to the processor for storing the program; wherein the program comprises:
configuring a plurality of MBSFN subframes in a cell; and
scheduling a downlink unicast transmission in an unused MBSFN subframe of the plurality of MBSFN subframes for a user equipment (UE);
wherein the UE is not receiving any Multimedia Broadcast Multicast Service (MBMS) service.

9. The communication device of claim 8, wherein the UE operates in an RRC-CONNECTED state.

10. The communication device of claim 8, wherein the UE monitors Physical Downlink Control Channel (PDCCH) in the plurality of MBSFN subframes, to get a downlink assignment during an active time.

11. The communication device of claim 10, wherein the active time is a period relates to a Discontinuous Reception operation during which the UE monitors PDCCH in a plurality of PDCCH-subframes.

12. The communication device of claim 8, wherein configuring the plurality of MBSFN subframes in the cell is via an information element SystemInformationBlockType2.

13. The communication device of claim 8, wherein the downlink unicast transmission is transmitted on a downlink shared channel.

14. The communication device of claim 8, wherein the program further comprising keeping a length of a control region in the unused MBSFN subframe, and setting a data region in the unused MBSFN subframe comprising information about PDSCH and a plurality of Cell-specific reference signals for the downlink unicast transmission.
